(19) United States
(12) Patent Application Publication
(10) Pub. No.: US 2012/0291618 A1
(43) Pub. Date: Nov. 22, 2012

(54) TEARDROP LATTICE STRUCTURE FOR HIGH SPECIFIC STRENGTH MATERIALS

(76) Inventor: JAY CLARKE HANAN, Sand Springs, OK (US)

(21) Appl. No.: 13/470,162

(22) Filed: May 11, 2012

Related U.S. Application Data
(63) Continuation-in-part of application No. 13/502,963, filed on Apr. 19, 2012.
(60) Provisional application No. 61/255,303, filed on Oct. 27, 2009.

(51) Int. Cl. F41H 5/04; B23P 11/00

(52) U.S. Cl. 89/36.02; 29/428; 89/912; 89/917

(57) ABSTRACT

A structure having a first energy absorbing polymer layer, and an energy absorbing honeycomb structure formed from a continuous segment of metallic glass material having a thickness substantially less than a width, the continuous strip being bent into a repeating pattern of a teardrop shape providing an outer radius and an inner point defined by two adjacent radii.

### CROSS REFERENCE TO RELATED APPLICATIONS

This application is a Continuation-in-Part of co-pending U.S. patent application Ser. No. 13/502,963 entitled “TEARDROP LATTICE STRUCTURE FOR HIGH SPECIFIC STRENGTH MATERIALS,” filed Apr. 19, 2012, which is a national entry of PCT/2010/054305 filed Oct. 27, 2010, which claims priority to expired U.S. Provisional Patent Application No. 61/255,303 filed Oct. 27, 2009, the contents of which each are hereby incorporated by reference.

### STATEMENT REGARDING FEDERALLY SPONSORED RESEARCH OR DEVELOPMENT

This invention was made with government support under ONR Grant No. N00173-07-1-G001 awarded by the Office of Naval Research. The government has certain rights in the invention.

### FIELD OF THE INVENTION

This disclosure relates to high strength materials in general and, more specifically, to lattice structured high strength materials.

### BACKGROUND OF THE INVENTION

Honeycombed or lattice structures may be manufactured based on cellular arrangements of known materials. Depending upon the constituent material and the method of producing the structure, desired properties such as load bearing ability and elasticity can be achieved. However, new materials, or those not previously used in developing cellular structures provide new challenges in determining the best way to exploit the inherent advantages and properties of certain materials.

What is needed is a system and method for addressing this, and related, issues.

### SUMMARY OF THE INVENTION

The invention of the present disclosure, in one aspect thereof, comprises a structure having a first energy absorbing polymer layer, and an energy absorbing honeycomb structure formed from a continuous segment of metallic glass material having a thickness substantially less than a width, the continuous strip being bent into a repeating pattern of a teardrop shape providing an outer radius and an inner point defined by two adjacent radii. The energy absorbing polymer layer forms a strike face such that a projectile will first encounter the energy absorbing polymer layer backed by the energy absorbing honeycomb structure.

In some embodiments the structure comprises a projectile eroding layer interposing the first energy absorbing polymer layer and the energy absorbing honeycomb structure. In some embodiments, this layer comprises silicon carbide.

A second energy absorbing polymer layer may interpose the projectile eroding layer and the energy absorbing polymer layer. A third energy absorbing polymer layer may be on a side of the energy absorbing honeycomb structure opposite the first energy absorbing polymer layer. In some embodiments, the first, second, and third energy absorbing polymer layers comprise an ultra high molecular weight polyethylene. The ultra high molecular weight polyethylene may be Dyneema HB-50.

A wrap layer may surround the first, second, and third energy absorbing polymer layers, the projectile eroding layer, and the energy absorbing honeycomb structure. The wrap layer may comprise Cordura or Kevlar.

The invention of the present disclosure, in another aspect thereof, comprises a structure having a first energy absorbing polymer layer, and an energy absorbing honeycomb structure. The energy absorbing polymer layer forms a strike faced that such that a projectile will first encounter the energy absorbing polymer layer backed by the energy absorbing honeycomb structure. In some embodiments, the energy absorbing honeycomb structure comprises a structure formed from a continuous segment of metallic glass material having a thickness substantially less than a width, the continuous strip being bent into a repeating pattern of a teardrop shape providing an outer radius and an inner point defined by two adjacent radii. In another embodiment, the energy absorbing honeycomb structure comprises Al 5052.

In some embodiments, the structure further comprises a projectile eroding layer interposing the first energy absorbing polymer layer and the energy absorbing honeycomb structure. A second energy absorbing polymer layer may interpose the projectile eroding layer and the energy absorbing polymer layer. The structure may comprise a third energy absorbing polymer layer on a side of the energy absorbing honeycomb structure opposite the first energy absorbing polymer layer.

The invention of the present disclosure, in another aspect thereof, comprises creating an energy absorbing honeycomb structure by providing a length of metallic glass alloy, bending the length of metallic glass alloy into a repeating pattern forming a plurality of cells, and fixing the length of metallic glass alloy into the repeating pattern by affixing the alloy to itself along cell borders. The method includes pairing the energy absorbing honeycomb structure with a first a first energy absorbing polymer layer, the energy absorbing polymer layer forming a strike face on the energy absorbing honeycomb layer.

In some embodiments, the method includes providing a projectile eroding layer interposing the energy absorbing polymer layer and the energy absorbing honeycomb structure. The method may include providing second and third energy absorbing polymer layers around the energy absorbing honeycomb structure. A projectile eroding layer may be provided between the second and third energy absorbing layers. A ballistic wrap may be provided surrounding the first, second, and third energy absorbing polymer layers, the projectile eroding layer, and the energy absorbing honeycomb layer.

### BRIEF DESCRIPTION OF THE DRAWINGS

FIG. 1 is a perspective view of segment of a lattice teardrop structure according to aspects of the present disclosure.

FIG. 2 is a top down view of a multilayered structure of teardrop lattice.

FIG. 3 is a top down view of a device for manufacturing teardrop lattice segments in a first, open configuration.

FIG. 4 is a top down view of the device of FIG. 3 in a second, closed position.

FIG. 5 illustrates a portion of the device of FIG. 3 showing how the completed lattice teardrop segment is removed from the device.

FIG. 6 is a side cutaway view of a section of composite armor according to aspects of the present disclosure.

### DETAILED DESCRIPTION

Metallic glass refers to a class of materials with an amorphous structure. They are often iron-nickel based alloys with lesser amounts of boron, molybdenum, silicon, carbon or phosphorous. They are made by abrupt quenching from the melt before the structure can crystallize. Their excellent magnetic properties allows them to find applications in fields such as electrical power, electronics, transduction and metal joining industries. They also posses good mechanical properties such as a yield strength of >3 GPa, which makes them potential candidates in load bearing applications.

The mechanical behavior of a structured material depends not only on the type and strength of constituent material that is used to build the structure, but also greatly depends on the geometry of the internal structure. Structural efficiency can be achieved by altering the shape factor in the microscopic as well as the macroscopic scale. A change in the material geometry impacts properties such as density, strength, and modulus.

Honeycombs are light weight cellular materials which have periodic arrangement of cells, walls of which support an applied load. High energy absorption characteristics, and a high strength to weight ratio of honeycombs finds various applications ranging from cushioning materials in packages to sandwich panels in aircraft. Metallic and non-metallic honeycombs exists for various applications. Most common manmade honeycomb structures are expanded aluminum honeycombs. Other classes of manmade honeycombs such as Aramid reinforced honeycombs, fiber glass reinforced honeycombs, and polyurethane honeycombs are also available.

Manufacturing Methods of Honeycomb Structures

Most high mechanical efficiency honeycomb structures are made using the expansion method where sheets of the base material from a web is cut into sheets of desired sizes, a high strength adhesive is applied on the face of the sheets in a staggered manner, and the sheets are stacked together until the adhesive is cured. Those layers can be cut into desired thickness and expanded to form honeycomb structures. Other conventional manufacturing methods used to make honeycombs include using a corrugated press where the material is corrugated using a gear press to form the desired shape. The corrugated sheets are then stacked together either using adhesives or by welding techniques. Both of these require plastic deformation of the constituent metal.

Other available methods for manufacturing honeycombs include assembling slotted metal strips (brittle honeycombs such as ceramic and some composite honeycombs are made using this method). Other methods such as investment casting, perforated metal sheet forming and wire/tube layup technique can also be used to manufacture lattice truss structures.

In order to make honeycombs out of amorphous metallic glass, the methods of the present disclosure have been developed. In various embodiments, these methods entail a bottom-up approach that differs from prior honeycomb processing methods.

Metallic Glass alloy used for first prototype: MB2826

In one embodiment of the present disclosure, MB2826 is utilized as the base material for a high strength structure. MB2826 is an iron-nickel-molybdenum based metallic glass (MG) alloy. It possesses excellent magnetic properties and has long found application in transformer cores. In one embodiment used with the present disclosure, the material is slip cast into thin metallic strips of about 28 μm in thickness and about 8 mm wide. MB2826 ribbon was chosen for one embodiment and for testing. However, it is understood that other MG alloys may be utilized in different embodiments.

As can be seen in Table 1 below, MB2826 metallic glass alloy possess superior mechanical properties when compared to that of Aluminum 5052, which is another material used for making honeycombs.

TABLE 1

| | Properties | | |
|---|---|---|---|
| | Yield Strength | Elastic Modulus | Elastic Strain |
| Material | (GPa) | (GPa) | Limit |
| Metallic Glass alloy | 1.9-2.7 | 100-110 | 2.0% |
| (MB2826) | | | |
| Aluminum 5052 | 0.2 | 70 | 0.4% |

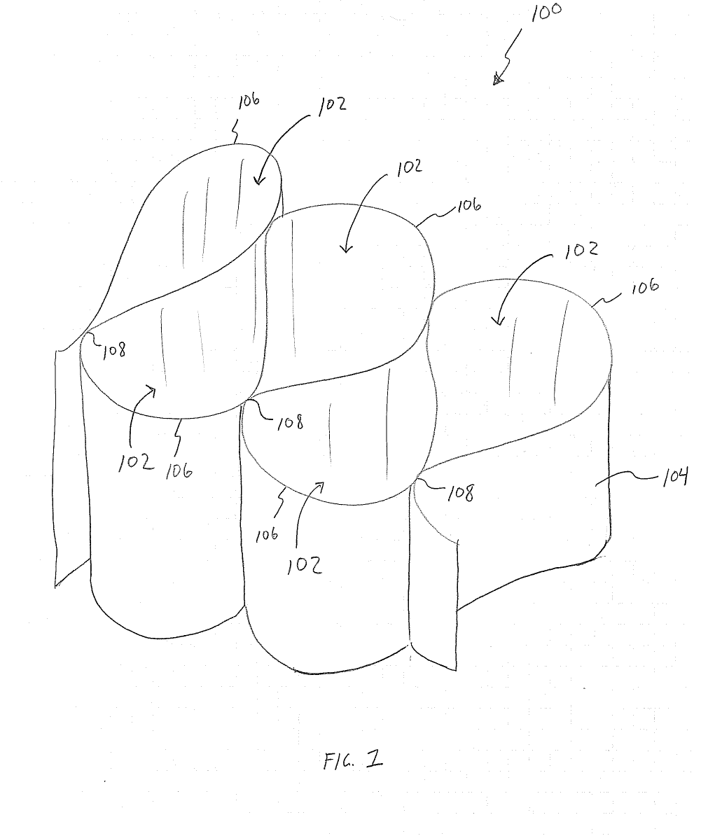

Referring now to FIG. 1, a perspective view of a segment of a lattice teardrop structure 100 according to aspects of the present disclosure is shown. In the present embodiment, a plurality of continuous teardrop shaped cells 102 are formed from a continuous strip of MB2826 104. The continuous strip 104 forms a substantially rounded radius 106 that contacts a neighboring radius in a competing pattern. The cells 106 form an apex or point 108 where they contact. This forms a repeating pattern of teardrop shaped cells rather than honeycombed, square, or another shape. The contact points 108 may be fused together or attached by an adhesive as explained below.

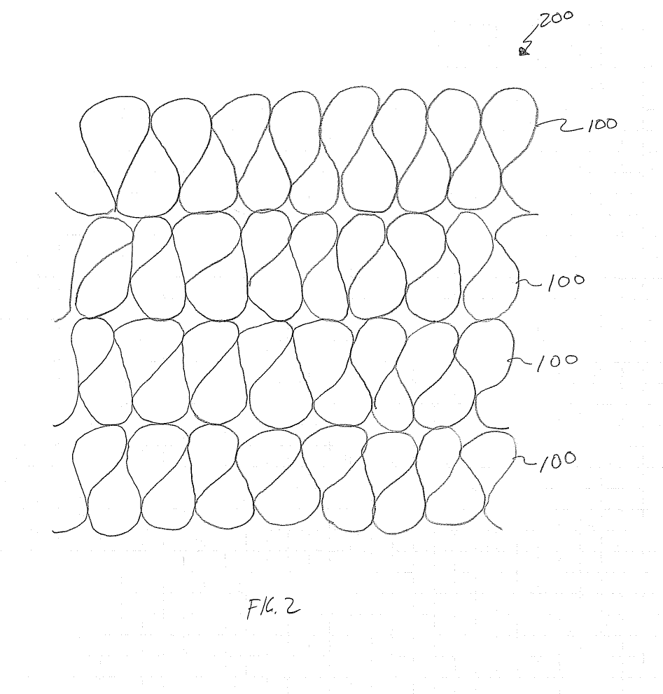

Referring now to FIG. 2, a top down view of a multilayered structure 200 of teardrop lattice is shown. Structures such as these may be formed by superposition of the repeating lattice structures 100. Once again, the structures 100 may be fused or adhered to one another to form the structure 200. In FIG. 2, the rounded radii 106 are shown generally in end-to-end contact with one another as between structures 100. However, in other embodiments, the structures 100 may be offset such that the rounded radii are interlaced as between structures 100. In such case, a radius 106 from one strip 100, will sit partially between two radii 106 from an adjacent strip 100.

Exemplary Manufacturing Method for Making “Teardrop” Shaped Mg Honeycombs:

The high elastic limit of metallic glass alloys can be taken advantage of in making teardrop shaped honeycomb structures. The metallic glass ribbon 100 can be shaped using a tool as shown in FIG. 3. The strip 100 can be alternatively bonded using an adhesive to form cells 102 in the shape of teardrop.

The honeycomb structure 100 as a whole is manufactured by starting from a single cell. Using an epoxy based adhesive system and by inducing an area constraint, the MG alloy 104 can be curved and bonded to its surface to form a cell 102 in the shape of a teardrop. Other forms of precision bonding techniques such as laser welding and electron beam welding can be employed for the same, provided they do not embrittle the alloy 104. Lattice rows 100 of desired lengths can be made and can be bonded together to form a complete “Teardrop” metallic glass honeycomb plate 200 as shown in FIG. 2.

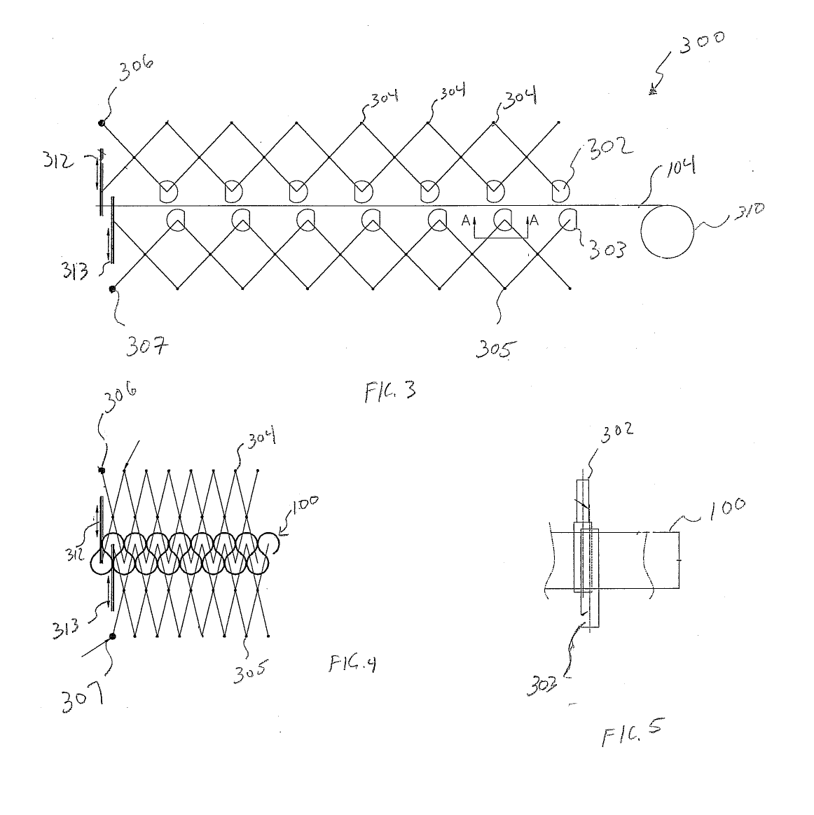

The device 300 of FIG. 3 begins with the MG alloy 104 spooling off a single spool 310. The strip 104 is fed between a first set of pins 302 and a second set of pins 303. The pin sets 302, 303 are movably mounted onto moveable hinges 304, 305, respectively. First and second sliding actuators 312, 313 actuate the pin and hinge system in an accordion-like fashion. This movement cause the pins 302, 304 to contact the strip 104, bending it into the aforedescribed repeating teardrop configuration. The device 300 is shown in a collapsed configuration in FIG. 4.

The strip 104 is now formed into the teardrop lattice structure 100. As mentioned, adhesives may be used to ensure that the structure 100 retains its shape. In other embodiments, laser welding or other means may be utilized to secure the structure 100 into shape.

Referring now to FIG. 5, a portion of the device 300 is shown. Here a first pin 302 is shown against a second pin 303. The pins 302 and 303 may be mounted from opposing directions. This allows the structure 100 to be removed from the device 300 without damage.

As with honeycombs, these new “teardrop” (TD) shaped MG honeycombs 100 are most effective and have superior mechanical properties in the out-of-plane direction. The in plane properties are also of interest for high compliance applications. The mechanical properties of the TD-MG honeycombs 100 can be predicted using the parent material properties.

In one analysis, by approximating the cells 102 of the “teardrop” shaped MG honeycombs 100 to be in the shape of hexagons, the compressive mechanical properties of the TD-MG honeycombs can be predicted. The predictions in table 2 below show comparable performance to aluminum honeycombs for our an MG ribbon based prototype, and suggest a two to four times improvement over aluminum honeycombs would be expected with Fe based BMG alloys.

TABLE 2
Measured properties in the early prototype

| | Material | | | |
|---|---|---|---|---|
| | “Teardrop” | “Teardrop” | “Teardrop” | |
| | shaped | shaped | shaped | |
| | Metallic | Metallic | Metallic | |
| Property in the | Glass | Glass | Glass | |
| out-of-plan | Honeycombs | Honeycombs | Honeycombs | Aluminum |
| (X₃) | (t/l = | (t/l = | (t/l = | Honeycombs |
| direction | 0.009) | 0.01) [1] | 0.05) [1] | (5052)* [2] |
| Density (g/cc) | 0.16 | 0.16 | 0.16 | 0.13 |
| Collapse Stress | 5.4 | 6.1 | 8.9 | 9.6 |
| (MPa) | | | | |
| Young's | 1.5 | 1.7 | 8.4 | 1.6 |
| Modulus (GPa) | | | | |
| Specific | 34 | 38 | 55 | 96 |
| Strength | | | | |
| Densification | 0.9 | 0.9 | 0.9 | 0.7 |
| Strain^{†} | | | | |
| (mm/mm) | | | | |
| Energy | 4.8 | 5 | 7.6 | 6.7 |
| absorption^{‡} | | | | |
| (J/mm³) | | | | |

*Properties of Aluminum Honeycomb correspond to that of AI5052 honeycomb from PLASCORE with the highest tensile strength.
^{†}Densification Strain values approximated from compression tests on TD-MG and Aluminum Honeycombs.
^{‡}Energy absorption calculated by approximating the area under the stress-strain curve in the X3 direction.

The (t/l) ratio of the TD-MG honeycombs that was considered for approximation is 0.01. By improving the method of manufacturing of the TD structures, by eliminating the flaws in the in alignment of the cells, and by stable and stronger bonding means; a reduction of 2× can be achieved in the cell size of the structure, which in turn increases the value of (t/l). Therefore, there will be significant increase in properties of strength and stiffness. This is easily done with automated manufacturing.

The high densification strain value of the TD-MG honeycombs adds to improved energy absorption characteristics.

It will be appreciate that a non-exhaustive list of properties of the MG honeycomb structure disclosed herein include: low density and light weight; high specific strength (high strength to weight ratio); greater energy absorption characteristics for its high value of strength and densification strain; high impact strength; and enhanced mechanical properties due to the high yield stress value of the MG alloy.

A non-exhaustive list of potential applications of the MG honeycomb structures disclosed herein include: energy absorbers in composite body armor; aerospace structure such as aircraft sandwich panels; automotive crashing test barriers; doors, ceilings and room panels; and passenger protective equipment in automobiles.

A Completed HCA Panel

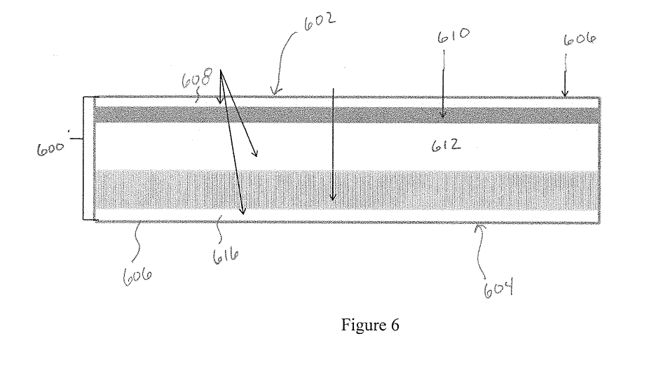

Referring now to FIG. 6, one embodiment of an armor panel utilizing a teardrop lattice structure of the present disclosure as a constituent layer is shown. In the present embodiment, the panel 600 is a multilayer structure having a strike face 602 which is meant to be the side from which projectiles will impact the panel 600. The panel 600 also has a back face 604 which is intended to face the user or wearer of the applicable armor.

An outer cordura wrap covers the structure 600 in the present embodiment. A first layer 608 of Dyneema HB-50 lies under the cordura wrap 608. In the present embodiment, this layer 608 is about 2 mm thick. Under this is a layer of silicon carbide 610 having a thickness of about 3.7 mm. Under the silicon carbide layer 610 is a second, interior layer 612 of Dyneema HB-50 having a thickness of about 10 mm. Under this is a layer 614 of high specific strength amorphous metal honeycomb (AMH) as described above (e.g., layer 100 of FIGS. 1-2). In some embodiments this layer 612 will have a thickness of about 8 mm. A third layer 616 of Dyneema HB-50 is below the AMH layer 614 and may have a thickness of about 2.2 mm. In some embodiments, the layers comprising Dyneema HB-50 (e.g., layers 608, 612, 616) may be grit blasted to provide better adhesion with adjacent layers.

It is understood that the layer and dimensions discussed above are only for purposes of illustration. For example, thicknesses of the various layers may be changed depending upon the desired characteristics of the final product. Furthermore not every embodiment will contain every layer illustrated. For example, the design illustrated in FIG. 6 is suitable for use as a Level IV Hybrid Composite Armor (HCA) product, but the first Dynema layer 606 and the silicon carbide layer 608 may be left out for a level III HCA product.

In some embodiments, Dyneema HB-50 laminate is used in layers 608, 612 to aid in intercepting and deforming incoming projectiles. This distributes the energy over a significantly large region to avoid local failures by force concentration. The function of sandwiched AMH 614 is to act as an energy diffuser after partial penetration of Dyneema front layers 608, 612, thereby reducing the back face deformation of the panel and resulting blunt trauma. As a final layer of protection against fragmentation, a thin laminate of Dyneema forms the backing spall liner, layer 616. In some embodiment, the functional sandwich core unit 612 was compact bonded with a Kevlar 29 wrap (not shown) to give further protection against spalling and exposure to elements. It is understood that adhesive and bonding and wrapping material may be chosen based upon desired performance, cost, and ease of manufacturing.

Various embodiments of the present disclosure may be classified as a purely passive absorber type armor as it relies on the material properties of the constituent materials and layers to dissipate impact kinetic energy. While dealing with an armor piercing threat, the front Dyneema layer 608 may not be able to significantly deform a hard steel projectile core. In such cases an additional material acting as the first impact layer to erode the projectile in to fragments was added (e.g., a disruptor). Hot Pressed Silicon Carbide (HP SiC) was selected for some embodiments (e.g., layer 610). This material has higher specific strength and hardness compared to the threat core in order to effectively erode any such core. In some embodiments, a multi-hit capability of the disruptor SiC layer 610 is improved by in-plane confinement (minimizing in-plane displacements so that the fragmented ceramic can still continue to offer protection). This may be accomplished by selecting a compact bonded rigid spall liner Dyneema layer 608 in the front as well. In some embodiments, a multi-plate mosaic construction of the front SiC layer 610 (e.g., instead of a monolith plate) can be used to improve multi-hit capability.

Details of the plate constituent layers with their arrangement and areal densities for one embodiment of the HCA shown in FIG. 6 are shown in Table 3. It is understood to represent only an exemplary embodiment, however.

TABLE 3
Areal Density calculation of a Level IV HCA insert (<6 lb/ft²).

| | Layer Material | | | | | | | |
|---|---|---|---|---|---|---|---|---|
| | Dyneema | Silicon | Dyneema | Al 5052 | Dyneema | Cordura | A21.2007 | |
| | HB-50 | Carbide | HB-50 | Honeycomb | HB-50 | Wrap | Film | |
| | (2 mm) | (3.7 mm) | (10 mm) | (8 mm) | (2.2 mm) | Material | Adhesive | |
| Areal | 0.39 | 2.56 | 1.94 | 0.32 | 0.43 | 0.208 | 0.13 | Total: |
| Density | | | | | | | | 5.978 |
| (lb/ft²) | | | | | | | | |

The material properties that make ceramics such as Silicon Carbide an excellent choice as disruptor armors (e.g., layer 610) are their high stiffness and hardness. SiC and boron carbide are harder materials with lower density than Alumina but cost more. However, their ability to defeat more tenacious threats with lower weight penalties weighs in their favor. Mode of manufacturing can significantly alter the properties of the final ceramic laminate and properties can also vary with different manufacturers (Ceramic Armour: Hazell, 2006). Therefore a comparison of ceramic armors is illustrated in Table 4. This comparison is based on a calculated Mass Efficiency Factor (Em) which represents the factor by which the areal density of a rolled homogenous armor witness material of thickness tc has to be multiplied to provide same protection. In brief, higher Em represents better performance.

TABLE 4
Comparison of Ceramic armor materials against Level IV
7.62 mm × 51 mm FFV AP (WC—Co core)
threat (Ceramic Armour: Hazell, 2006).

| | | t_{c} | Calculated | |
|---|---|---|---|---|
| Ceramic | Manufacturer | (mm) | Eₘ | Witness Material |
| HP SiC | Ceradyne Inc. | 6.5 | 5.0 | Al 6082-T651 |
| HP B₄C | | 6.5 | 2.5 | YS = 250 MPa |
| RS Si₃N₄ | | 6.5 | 2.2 | Depth of |
| HP TiB₂ | | 6.6 | 3.4 | penetration: 75 mm |
| Sintered SiC | Morgan AM&T | 5.9 | 3.7 | without ceramic. |
| Sintered SiC | Wacker-Chemie | 6.1 | 4.8 | |
| LPS SiC | AME | 6.1 | 3.3 | |
| RB SiC | Morgan AM&T | 7.2 | 1.3 | |
| RB SIC | Haldenwanger | 6.2 | 1.2 | |
| RB SiC | Schunk | 6.0 | 1.5 | |
| RB B₄C | M-Cubed | 7.0 | 1.2 | |

Review of Table 4 indicates that HP SiC demonstrates a better ballistic performance and hence is a better choice for at least some embodiments of the current disclosure. HP SiC is also easier to process, having fewer defects when manufactured to scale, as compared to some other potential materials. This is a significant factor for fracture toughness and also for availability when attempting to deploy a large number of plates.

Ballistic performance of armor grade fabric systems is quantified with respect to their ability to: (a) absorb the entire projectile's kinetic energy locally; and (b) spread out the absorbed energy fast before local conditions for the failure are met. Numerically, this corresponds to Energy Absorption Capacity per unit mass (Eₛₚ) and the speed of sound in the material. In some embodiments of the present disclosure, it was determined that the best choice was an ultra high molecular weight polyethylene (UHMWPE). Commercially available brands of UHMWPE are Spectra (Honeywell Co.) and Dyneema (DSM Co.), with Dyneema HB-50 being used in the Dynema layers 608, 612, and 616 shown in FIG. 6.

Use of the AMH layer 616 as a second tier absorber in HCA means that considerable addition in strength along the thickness direction of the armor plate 600 can be achieved with minimum addition in areal density. This is due to the high strength-to-weight ratio of the AMH 616. The collapsible structure of the AMH 616 enables irreversible energy dissipation through plastic deformation. Being of cellular morphology, the AMH 616 enables efficient control of the energy absorbed, reactive force, and stroke through a tailored stress plateau by governing porosity.

Inherent high strength, high elastic modulus, and achievable low density through porosity prompted the selection of amorphous metals as a base material for the cellular structure. The composition of the base amorphous metal alloy used for making the teardrop honeycomb lattice is (Fe₄₅Ni₄₅Mo₇B₃). The precursor for the cellular structure may be obtained as fully processed slip-cast ribbons from MetGlass Inc. The cells in the honeycomb structure 614 were made from a bottom-up manufacturing approach as described above.

In another embodiment, the AMH layer 614 is replaced by Hexcel® Al 5052 12.0-1/8-0.003N CORR honeycomb. Both these honeycombs have identical areal density (0.32 lb/ft2 or 1.56 kg/m2) and very close mechanical performance.

Some embodiments use A21.2007 adhesive film by Nolax® to bond the constituent layers of the armor insert 600. Other embodiments may use the DP-110 industrial grade adhesive system by 3M®. As previously mentioned, Nylon based Cordura may be used as the wrap material 606. However, Kevlar® 29 may also be used.

Ballistic testing has been performed on various embodiments of armor panels according to the present disclosure. One embodiment, designated HCA-P1 has a first Dynema layer 14 mm thick, over an 8 mm AMH layer, over a second, 3 mm Dynema layer. These figures are further detailed in Table 5. Another embodiment, designated HCA-P2, was tested in two variations. Variation 1 had an 8 mm Al 5052 insert between Dyneema layers of 14 mm and 3 mm, respectively. Variation 2 had an 8 mm Al 5052 insert between Dyneema layers of 12 mm and 2.2 mm, respectively. Figures for the HCA-P2 version are detailed in Table 6.

TABLE 5
Summary of test results for the HCA-P1 prototype.

| | Areal | Average | Average |
|---|---|---|---|
| | density | Velocity | BFS |
| Type of Insert | (lb/ft²) | (ft/s) | (mm) |
| Baseline Insert | 3.45 | 2621 | 42.8 |
| (14 mm Dyneema + 3 mm Dyneema) | | | |
| HCA-P1 insert | 3.88 | 2672 | 33.6 |
| (14 mm Dyneema + 8 mm AMH + 3 mm | | | |
| Dyneema) | | | |
| Difference | 0.43 | 51 | 9.2 |

TABLE 6
Summary of test results for the HCA-P2 prototype.

| | Areal | Average | V₅₀ | |
|---|---|---|---|---|
| | density | Velocity | Velocity | Average |
| Type of Insert | (lb/ft²) | (ft/s) | (ft/s) | BFS |
| Variant-1 Baseline Insert | 4.10 | 2740 | 3123 | 29.5 mm |
| (10 mm Dyneema + 10 | | | | reduced |
| mm Dyneema) | | | | BFS in |
| Variant-1 HCA-P2 insert | 4.13 | 2769 | 3246 | HCA-P2 |
| (14 mm Dyneema + 8 | | | | |
| mm Al 5052 | | | | |
| Honeycomb + 3 | | | | |
| mm Dyneema) | | | | |
| Variant-2 Baseline Insert | 3.35 | 2756 | 2848 | 11.5 mm |
| (14 mm Dyneema) | | | | reduced |
| Variant-2 HCA-P2 insert | 3.39 | 2760 | 2760 | BFS in |
| (12 mm Dyneema + 8 | | | | HCA-P2 |
| mm Al 5052 | | | | |
| Honeycomb + 2.2 | | | | |
| mm Dyneema) | | | | |

The test method for all armor inserts was according to the standards specified for a level III armor insert in NIJ 0101.06. These tests were conducted at the courtesy of DSM Dyneema testing range (North Carolina) and US Shooting Academy (Tulsa, Okla.). The projectile selected for tests was the 0.308 WIN 7.62 mm FMJ round (9.8 g weight), equivalent of the 7.62 mm NATO FMJ (9.6 g weight) that NIJ suggests. Measurements of Back Face Signature (BFS) and V50 velocities were performed according to the standard. For effective comparison, baseline, Dyneema-only inserts of similar areal density were also shot along with the HCA prototypes. Post ballistic testing, the shot HCA-P1 inserts were observed for deformation distribution and prediction of failure modes using a CT scans at Servant Medical Imaging in Stillwater, Okla.

The summary of test results for the HCA-P1 prototype is shown in Table 5. The 3.45 lb/ft2 average areal density baseline inserts resulted in an average BFS of 42.8 mm for 2621 ft/s average velocity. In comparison, for a higher average velocity of 2672 ft/s, the composite inserts exhibited a reduced average BFS of 33.6 mm (Average values have been calculated from testing 2 all-Dyneema baseline inserts and 4 HCA-P1 inserts with 4-6 shots/insert).

General observation and CT scan imaging suggested the fracture and damage modes observed in HCA-P1 were identical to those reported by the scientific community so far for UHMWPE based armors. However, these scans also revealed reduction in damage zones for the HCA-P1 in comparison to the baseline insert (134 cm2 for baseline and 122 cm2 or lower for HCA-P1); validating improved multi hit capability by inclusion of the honeycomb layer. HCA-P1 demonstrated a V50 of 2730 ft/s (832 m/s), close to the mandatory requirement by NIJ to clear a level III standard evaluation test.

Summary of the results of the test of the variations of the HCA-P2 insert are shown in Table 6. The 14 mm front layer variant of the HCA-P2 (areal density 4.1 lb/ft2) demonstrated a BFS reduction of 29.5 mm as compared to the baseline (reduction by 38%) with a V50 of 3246 ft/s (989 m/s). The 12 mm front layer variant of HCA-P2 (areal density 3.4 lb/ft2) demonstrated 11.5 mm of BFS reduction (reduction by 16%) with a V50 of 2760 ft/s (841 m/s).

The ballistic test results indicate that today's best Level III armor solutions (all Dyneema/UHMWPE) available commercially do not meet the BFS reduction capabilities and protection provided by the embodiments of hybrid composite armor panels described in the present disclosure. With various embodiments of the present disclosure, the NIJ requirements (BFS<44 mm, V50>2750 ft/s) can be exceeded at the same weight.

In another embodiment, an insert having a 6.3 mm thick silicon carbide layer 610 upon the variant-2 of HCA-P2 insert may form a panel 600.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

### REFERENCES

[1] Properties of specific strength and Modulus calculated from “Cellular Solids” by Ashby considering double cell wall thickness.
[2] Mechanical Properties of Aluminum Honeycombs referred from www.plascore.com (3/160.003-5052).
[3] Tensile tests on Metallic Glass ribbons.
[4] B. Jayakumar, A. Bhat, J. C. Hanan, “Mechanical Properties of Amorphous Metal Honeycombs for Ballistic Applications,” ASME International Mechanical Engineering Congress (2009).
[5] A. Bhat, “Finite Element Modeling and Dynamic Impact Response Evaluation for Ballistic Applications,” MS Thesis, Oklahoma State University, USA (2009).
[6] B. Jayakumar, “Metallic Glass Honeycombs and Composite Body Armor,” MS Thesis, Oklahoma State University, USA (2009).
[7] B. Jayakumar, J. C. Hanan, “Modeling the axial response of amorphous Fe45Ni45Mo7B3 honeycombs,” Metallurgical and Materials Transactions A, vol. (In press) (2011).
[8] A. Bhat, J. C. Hanan, “Dynamic Compressive Behavior of Fe Based Amorphous Metal Honeycomb Cellular Structures,” TMS Annual Meeting and Exhibition (2011). In review

What is claimed is:

1. A structure comprising:
a first energy absorbing polymer layer; and
an energy absorbing honeycomb structure formed from a continuous segment of metallic glass material having a thickness substantially less than a width, the continuous strip being bent into a repeating pattern of a teardrop shape providing an outer radius and an inner point defined by two adjacent radii;
wherein the energy absorbing polymer layer forms a strike face such that a projectile will first encounter the energy absorbing polymer layer backed by the energy absorbing honeycomb structure.

2. The structure of claim 1, further comprising a projectile eroding layer interposing the first energy absorbing polymer layer and the energy absorbing honeycomb structure.

3. The structure of claim 2, further comprising a second energy absorbing polymer layer interposing the projectile eroding layer and the energy absorbing polymer layer.

4. The structure of claim 3, further comprising a third energy absorbing polymer layer on a side of the energy absorbing honeycomb structure opposite the first energy absorbing polymer layer.

5. The structure of claim 4, further comprising a wrap layer surrounding the first, second, and third energy absorbing polymer layers, the projectile eroding layer, and the energy absorbing honeycomb structure.

6. The structure of claim 5, wherein the wrap layer comprises Cordura.

7. The structure of claim 5, wherein the wrap layer comprises Kevlar.

8. The structure of claim 4, wherein the first, second, and third energy absorbing polymer layers comprise an ultra high molecular weight polyethylene.

9. The structure of claim 4, wherein the first, second, and third energy absorbing polymer layers comprise Dyneema HB-50.

10. The structure of claim 4, wherein the projectile eroding layer comprises silicon carbide.

11. A structure comprising:
a first energy absorbing polymer layer; and
an energy absorbing honeycomb structure;
wherein the energy absorbing polymer layer forms a strike faced that such that a projectile will first encounter the energy absorbing polymer layer backed by the energy absorbing honeycomb structure.

12. The structure of claim 11, wherein the energy absorbing honeycomb structure comprises a structure formed from a continuous segment of metallic glass material having a thickness substantially less than a width, the continuous strip being bent into a repeating pattern of a teardrop shape providing an outer radius and an inner point defined by two adjacent radii.

13. The structure of claim 11, wherein the energy absorbing honeycomb structure comprises Al 5052.

14. The structure of claim 11 further comprising a projectile eroding layer interposing the first energy absorbing polymer layer and the energy absorbing honeycomb structure.

15. The structure of claim 14, further comprising:
a second energy absorbing polymer layer interposing the projectile eroding layer and the energy absorbing polymer layer; and
a third energy absorbing polymer layer on a side of the energy absorbing honeycomb structure opposite the first energy absorbing polymer layer.

16. A method comprising:
creating an energy absorbing honeycomb structure by providing a length of metallic glass alloy, bending the length of metallic glass alloy into a repeating pattern forming a plurality of cells, and fixing the length of metallic glass alloy into the repeating pattern by affixing the alloy to itself along cell borders; and
pairing the energy absorbing honeycomb structure with a first a first energy absorbing polymer layer, the energy absorbing polymer layer forming a strike face on the energy absorbing honeycomb layer.

17. The method of claim 16, further comprising providing a projectile eroding layer interposing the energy absorbing polymer layer and the energy absorbing honeycomb structure.

18. The method of claim 17, further comprising providing second and third energy absorbing polymer layers around the energy absorbing honeycomb structure.

19. The method of claim 18, further comprising providing a projectile eroding layer between the second and third energy absorbing layers.

20. The method of claim 19, further comprising providing a ballistic wrap surrounding the first, second, and third energy absorbing polymer layers, the projectile eroding layer, and the energy absorbing honeycomb layer.
